(19) United States
(12) Patent Application Publication
(10) Pub. No.: US 2005/0099751 A1
(43) Pub. Date: May 12, 2005

(54) Semiconductor device having overcurrent protection function and data setting method thereof

(75) Inventor: Toshiyuki Kumagai, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Mitsubishi Denki Kabushiki Kaisha, Tokyo (JP); Renesas Device Design Corp., Itami-shi (JP)

(21) Appl. No.: 10/862,627

(22) Filed: Jun. 8, 2004

(30) Foreign Application Priority Data
Nov. 12, 2003 (JP) 2003-382256

(51) Int. Cl. H02H 3/00

(52) U.S. Cl. 361/100

(57) ABSTRACT

In a driving device (20) for driving an IGBT (1), a current measuring portion (22) measures a main current amount flowing through the IGBT (1). When the main current amount measured by the current measuring portion (22) reaches a predetermined reference level, a protection circuit portion (23) limits the main current at the IGBT (1) to protect it. A temperature measuring portion (24) measures the temperature of the IGBT (1). The control portion (25) adjusts the aforementioned reference level based on the temperature of the IGBT (1) measured by the temperature measuring portion (24). A control portion (35) stores setting values of the reference level as data.

### BACKGROUND OF THE INVENTION

1. Field of the Invention

This invention relates to a semiconductor device suitable for use in a power converter such as an inverter. More particularly, this invention relates to an improvement to realize reduced or eliminated temperature dependence in an overcurrent detection function.

2. Description of the Background Art

A semiconductor device for driving a switching element such as an insulated gate bipolar transistor (IGBT) element and having an overcurrent detection function to detect a current exceeding a predetermined limit (an overcurrent) flowing through the switching element is generally used in a power converter such as an inverter. A semiconductor device with such a function and further having a protection function to limit a main current based on an overcurrent detection result (an overcurrent protection function) is known as an intelligent power module (hereinafter referred to as an “IPM”). The IPM is especially suitable for use in a power converter.

A switching element driven by the IPM generally includes a sense electrode through which a sense current divided from a main current (a collector current when the switching element is the IGBT) flows. The amount of the sense current dividing into the sense electrode is smaller than that of the main current. Since the amount of the sense current is proportional to the amount of the main current, the sense current is used to measure the amount of the main current to detect the overcurrent. The amount of the main current varies in response to the size of a voltage that is applied to a control electrode of the switching element (a gate electrode when the switching element is the IGBT).

The IPM measures the amount of the main current flowing through the switching element based on the amount of the sense current. When the main current value reaches a predetermined reference level used for overcurrent detection, the IPM controls the voltage to be applied to the control electrode of the switching element (a control voltage) and limits the main current, thereby protecting the switching element. In other words, the IPM controls the control voltage based on the overcurrent detection result to avoid continual flow of the overcurrent through the switching element. Performed in this manner, the overcurrent protection function of the IPM serves to prevent failure of the switching element caused by the overcurrent.

The ratio of a main current to a sense current in an IGBT, that is a diversion ratio (which is obtained by dividing the sense current by the main current), varies in dependence on temperature and a larger sense current tends to be outputted with a rise in temperature. Especially, in recent years, current capacity of IGBTs have been increased and IGBTs have been miniaturized in order to suppress switching losses that accompany the increased current capacity, the temperature dependence of the diversion ratio has reached an unignorable level.

Since the amount of the main current is measured based on the amount of the sense current, the main current value to be measured varies in accordance with a change of the diversion ratio affected by temperature changes. The temperature of the IGBT varies due to its application environment and self-heating and thus the main current value of a conventional IPM is measured variedly in accordance with temperature. This causes an overcurrent detection level to vary in accordance with temperature. Therefore, it is difficult to precisely detect the overcurrent and thus it is difficult to accurately implement overcurrent protection in the conventional IPM.

In order to solve this problem, for example, Japanese Patent Application Laid-Open Nos. 08-019164 (pages 4-7, FIGS. 1-5) and 2003-009509 (page 4, FIG. 3) suggest some IPMs to remedy the situation that the overcurrent detection level varies according to temperature. Japanese Patent Application Laid-Open No. 08-019164 describes optimization of temperature coefficients of resistor elements included in the IPM. Specifically, respective temperature coefficients of the resistor element for converting the sense current into a voltage signal and a resistor for generating a voltage as a reference used in overcurrent detection are optimized for setting. This remedies the situation that the overcurrent detection level varies according to temperature.

Japanese Patent Application Laid-Open No. 2003-009509 discloses the IPM provided with a temperature measuring diode for measuring the temperature of the switching element and a correction circuit for correcting a main current value at the switching element measured based on the amount of the sense current. In the IPM, the temperature of the switching element measured by the diode is used to correct the main current value derived from the sense current. This remedies the situation that the overcurrent detection level of the IPM varies according to temperature.

In a conventional IPM, it is difficult to change the overcurrent detection level once it is set. For example, the IPM disclosed in Japanese Patent Application Laid-Open No. 08-019164 requires the temperature coefficients of the resistor elements to be changed. This accompanies hardware modification such as replacing the resistor elements. Further, the IPM disclosed in Japanese Patent Application Laid-Open No. 2003-009509 requires an operation coefficient in the correction circuit to be reset. For this purpose, it is necessary to manually conduct evaluation and confirmation procedures to determine the overcurrent detection level using a measuring instrument such as an oscilloscope. In this case, individual differences or errors might occur in measurement results.

For the IPM disclosed in Japanese Patent Application Laid-Open 2003-009509, the correction circuit for correcting the main current value derived from the sense current requires an amplifier circuit and the like. This is problematic leading to enlarged circuit size.

### SUMMARY OF THE INVENTION

It is an object of the present invention to provide a semiconductor device with an overcurrent protection function for a switching element such as an IPM wherein the situation that an overcurrent detection level varies in dependence on temperature can be remedied and the setting of the overcurrent detection level can be easily changed.

According to a first aspect of the present invention, a semiconductor device drives a predetermined switching element and has a protection function preventing an overcurrent from flowing through the switching element. The semiconductor device includes a current measuring portion, a protection circuit portion, a temperature measuring portion, and a control portion. The current measuring portion measures an amount of current flowing through the switching element. The protection circuit portion limits the current flowing through the switching element when the amount of the current measured by the current measuring portion reaches a predetermined reference level for detecting the overcurrent, thereby protecting the switching element. The temperature measuring portion measures the temperature of the switching element. The control portion adjusts the reference level based on the temperature of the switching element measured by the temperature measuring portion. The reference level is predetermined in correspondent to the temperature of the switching element on the assumption that the temperature changes. The control portion adjusts the reference level in correspondent to the measured temperature.

Since the reference level for overcurrent detection is adjusted based on the temperature of the switching element measured by the temperature measuring portion, the situation that the overcurrent detection level varies in dependence on temperature is remedied. Further, in comparison with the case of Japanese Patent Application Laid-Open No. 2003-009509 where the operation coefficient in the correction circuit is reset, the setting of the overcurrent detection level can be easily changed. Furthermore, in comparison with the case of Japanese Patent Application Laid-Open No. 2003-009509 where the measured current value is corrected by the correction circuit, reduction of the circuit size can be achieved.

According to a second aspect of the present invention, a data setting method of the reference level for detecting the overcurrent is applied to a semiconductor device for driving a predetermined switching element and having a protection function for preventing an overcurrent from flowing through the switching element. The semiconductor includes a current measuring portion, a protection circuit portion, a temperature measuring portion, and a control portion. The current measuring portion measures an amount of current flowing through the switching element. The protection circuit portion limits the current flowing through the switching element when the amount of the current measured by the current measuring portion reaches a predetermined reference level for detecting the overcurrent, thereby protecting the switching element. The temperature measuring portion measures the temperature of the switching element. The control portion adjusts the reference level based on the temperature of the switching element measured by the temperature measuring portion. The control portion includes a memory and a reference level controller. The memory holds data of the reference level related to respective temperatures of the switching element. The reference level controller reads data of the reference level related to the temperature of the switching element measured by the temperature measuring portion from the memory and adjusts the reference level based on the data. Further, the data setting method includes the following steps of (a) through (d). The step (a) is to apply a current of a predetermined level to the switching element. The step (b) is to set the switching element at a predetermined temperature. The step (c) is to measure the amount of the current flowing through the switching element by the current measuring portion and measure the temperature of the switching element at the time by the temperature measuring portion. The step (d) is to control the memory to hold the amount of the current and the temperature measured in the step (c) as the data of the reference level by relating each other.

By changing the temperature of the semiconductor device and providing the main current equivalent to the overcurrent level to the switching element, data of a new reference level is automatically created. Therefore, a user does not have to prepare new reference level data in advance. Further, even if the procedure is conducted manually, no individual differences or errors occurs in measurement results. Therefore, an improved reliability of the semiconductor device is realized.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows the structure of a semiconductor device (an IPM) according to a preferred embodiment;

FIG. 2 shows the structure of a driving device included in the semiconductor device according to the preferred embodiment;

FIG. 3 shows the structure of data stored in a non-volatile memory included in the semiconductor device according to the preferred embodiment;

FIG. 4 illustrates changes of a reference level for overcurrent detection in the semiconductor device according to the preferred embodiment; and

FIG. 5 is a flowchart illustrating a second data setting mode of the semiconductor device according to the preferred embodiment.

### DESCRIPTION OF THE PREFERRED EMBODIMENTS

<Structure of Semiconductor Device>

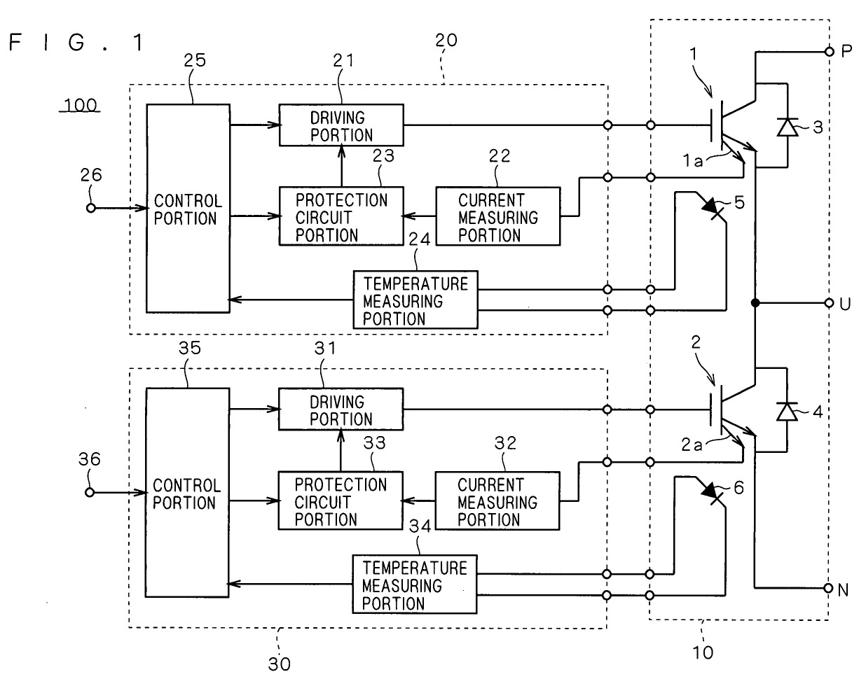

FIG. 1 shows the structure of an IPM semiconductor device according to a preferred embodiment of the present invention. An IPM 100 comprises an inverter 10 and driving devices 20 and 30 for driving the inverter 10. The inverter 10 comprises two switching elements connected in series to each other, namely, an IGBT 1 on the P side and an IGBT 2 on the N side, each serving as an output element for driving a load (not shown). The IGBTs 1 and 2 are provided with sense electrodes 1a and 1b, respectively, where a sense current proportionate to a main current (a collector current) flows therethrough. The IPM 100 further comprises free-wheeling diodes 3 and 4, connected to the IGBTs 1 and 2, respectively, and temperature measuring diodes 5 and 6 for measuring respective temperatures of the IGBTs 1 and 2.

The driving device 20 drives the IGBT 1 and is provided with an overcurrent protection function for preventing an overcurrent from flowing through the IGBT 1. The driving device 20 further comprises a driving portion 21, a current measuring portion 22, a protection circuit portion 23, a temperature measuring portion 24, and a control portion 25. The driving portion 21 drives the IGBT 1 based on instructions from the control portion 25 and the protection circuit portion 23. The current measuring portion 22 measures the main current value flowing through the IGBT 1 based on the amount of the sense current flowing through the sense electrode 1a of the IGBT 1. When the current value measured by the current measuring portion 22 reaches a predetermined reference level (hereinafter occasionally referred to simply as a “reference level”), the protection circuit portion 23 instructs the driving portion 21 to protect the IGBT 1 by cutting off (limiting) the main current flowing through the IGBT 1. The temperature measuring portion 24 uses the temperature measuring diode 5 to measure the temperature of the IGBT 1. The control portion 25 controls performance of the driving portion 21 and adjusts the aforementioned reference level of the protection circuit portion 23 based on the temperature of the IGBT 1 measured by the temperature measuring portion 24. The range of adjustment is predetermined in relation to assumed temperature changes of the IGBT 1 driven by the driving device 20. The control portion 25 has a data communication function for exchanging data with an external device through a data input/output terminal 26.

The driving device 30 drives the IGBT 2 and is provided with the overcurrent protection function for preventing the overcurrent from flowing through the IGBT 2. As shown in FIG. 1, the driving devices 20 and 30 are configured in the same manner. Specifically, the driving device 30 comprises a driving portion 31, a current measuring portion 32, a protection circuit portion 33, a temperature measuring portion 34, a control portion 35, and a data input/output terminal 36. Each of these elements has the same function as those described above for the driving portion 21, the current measuring portion 22, the protection circuit portion 23, the temperature measuring portion 24, the control portion 25, and the data input/output terminal 26, respectively. Therefore, description of these elements is omitted.

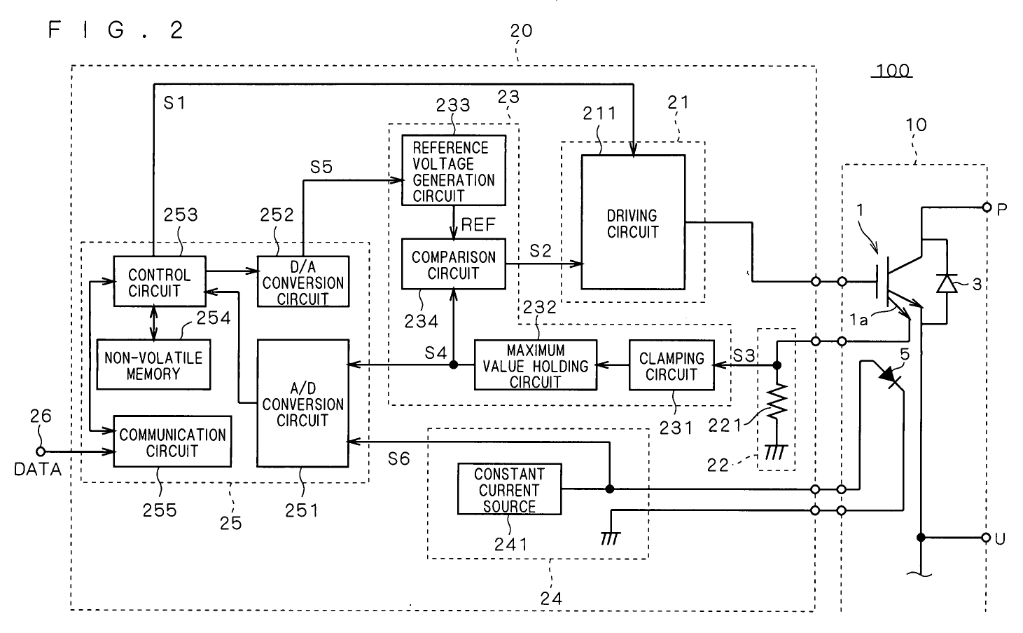

FIG. 2 shows detailed structure of the driving device 20. Hereinafter description of the structure and operation of the IPM 100 is given in reference to FIG. 2. Since the driving devices 20 and 30 have the same configuration, description of the driving device 30 is omitted.

A driving circuit 211 included in the driving portion 21 generates a voltage to be applied to a gate terminal of the IGBT 1. The driving circuit 211 drives the IGBT 1 in response to a driving signal S1 from the control portion 25. When receiving a protection signal S2 from the protection circuit portion 23, the driving circuit 211 ignores the driving signal S1 and controls the voltage to be applied to the gate terminal of the IGBT 1 so that the main current to the IGBT 1 is cut off.

The current measuring portion 22 comprises a resistor element 221 for converting a current outputted from the sense electrode la into a voltage. That is, the resistor element 221 measures a main current value at the IGBT 1 by outputting a voltage signal (a current measuring signal S3) indicating the amount of the main current flowing through the IGBT 1.

The protection circuit portion 23 comprises a clamping circuit 231, a maximum value holding circuit 232, a reference voltage generation circuit 233, and a comparison circuit 234. The clamping circuit 231 fixes a predetermined portion of the waveform of the inputted current measuring signal S3 at a constant level of voltage. More specifically, the clamping circuit 231 functions to eliminate noise generated in the current measuring signal S3 when the IGBT 1 is turned on. The maximum value holding circuit 232 receives the noise-free current measuring signal S3 from the clamping circuit 231 and outputs a maximum current signal S4. The maximum current signal S4 is a voltage signal holding the maximum value of the current measuring signal S3. The reference voltage generation circuit 233 outputs a reference voltage REF indicating the reference level for overcurrent detection. The size of the reference voltage REF from the reference voltage generation circuit 233 is controlled by a reference level control signal S5 from the control portion 25. The comparison circuit 234 compares the maximum current signal S4 and the reference voltage REF and outputs the protection signal S2 to the driving circuit 211 when the maximum current signal S4 exceeds the reference voltage REF.

The temperature measuring portion 24 comprises a constant current source 241 for providing a constant amount of current to the temperature measuring diode 5. A property of the temperature measuring diode 5 is that as the temperature of the diode 5 rises with the constant amount of current flowing therethrough, the temperature measuring diode 5 exhibits a smaller voltage drop. Therefore, by measuring a voltage generated at both ends of the temperature measuring diode 5, it is possible to measure the temperature of the IGBT 1. The measured voltage is transmitted to the control portion 25 as a temperature measuring signal S6 indicting the temperature of the IGBT 1.

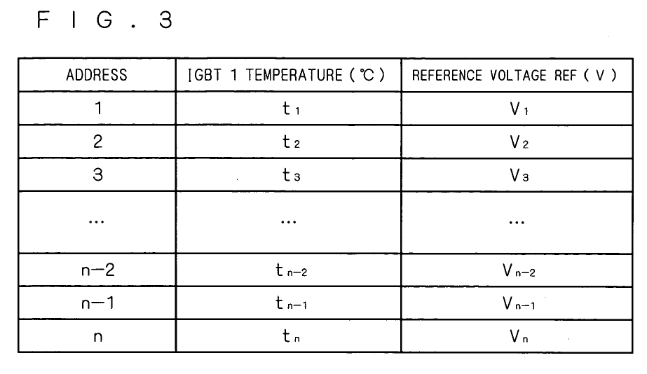

The control portion 25 comprises an A/D (analog/digital) conversion circuit 251, a D/A (digital/analog) conversion circuit 252, a control circuit 253, a non-volatile memory 254, and a communication circuit 255. The A/D conversion circuit 251 receives the maximum current signal S4 from the protection circuit portion 23 and the temperature measuring signal S6 from the temperature measuring portion 24, digitally converts the signals and outputs them to the control circuit 253. Data stored in the non-volatile memory 254 in advance include a reference level that is related to an assumed temperature that the IGBT 1 can take. FIG. 3 shows the structure of the data in the non-volatile memory 254. Each address of the non-volatile memory 254 (1, 2, . . . , n) stores reference level data comprising data of the reference voltage REF (V₁, V₂, . . . , Vₙ) in a corresponding relation to temperature data of the IGBT 1 (t₁, t₂ . . . , tₙ). The communication circuit 255 exchanges data with the external device through the data input/output terminal 26. The control circuit 253 can control the non-volatile memory 254 so that data received from the A/D conversion circuit 251 and the communication circuit 255 is stored in the non-volatile memory 254.

The control circuit 253 controls the driving circuit 211 with the driving signal S1 so that the IGBT 1 performs a predetermined operation. The control circuit 253 also monitors the temperature of the IGBT 1 based on the temperature measuring signal S6 digitized by the A/D conversion circuit 251. The control circuit 253 retrieves the reference voltage REF data related to the temperature of the IGBT 1 at a given moment from the non-volatile memory 254 and transmits the data to the D/A conversion circuit 252. The data is converted by the D/A conversion circuit 252 into an analog signal of the reference level control signal S5 and then inputted into the reference voltage generation circuit 233. The reference voltage generation circuit 233 generates the reference voltage REF of a size in accordance with the reference level control signal S5. As a result, the reference voltage REF outputted from the reference voltage generation circuit 233 has the same value as the reference voltage REF data retrieved from the non-volatile memory 254 by the control circuit 253.

In other words, when the non-volatile memory 254 has data stored as shown in FIG. 3, for example, if the temperature of the IGBT 1 is t₁ (C°), the reference voltage REF generated by the reference voltage generation circuit 233 is set to be V₁ (V). As the temperature of the IGBT 1 changes to t₂, t₃, . . . , (C°), accordingly the reference voltage REF generated by the reference voltage generation circuit 233 changes to V₂, V₃, . . . , (V). In this manner, the driving device 20 realizes a function of changing reference levels for overcurrent detection by changing the reference voltage REF in accordance with the temperature of the IGBT 1.

<Operation of Semiconductor Device>

Operation of the semiconductor device (the IPM 100) according to the present preferred embodiment is described. Since the driving devices 20 and 30 shown in FIG. 1 perform almost in the same manner, description is given mainly of the operation of the driving device 20 here and description of the driving device 30 is omitted.

In a normal operation of switching the main current, the driving circuit 211 included in the driving device 20 drives the IGBT 1 based on the driving signal S1 from the control circuit 253. At this time, the amount of the main current flowing through the IGBT 1 is measured through the sense electrode la and the resistor element 221. The current measuring signal S3 that is a voltage signal of the size in proportion to the amount of the main current is inputted into the clamping circuit 231. The clamping circuit 231 removes noise generated when the IGBT 1 is turned on from the current measuring signal S3, and the noise-free current measuring signal S3 is transmitted to the maximum value holding circuit 232. Then the maximum current signal S4 that is a voltage signal holding the maximum value of the current measuring signal S3 is obtained. That is, the size of the maximum current signal S4 corresponds to the maximum value of the main current that flows through the IGBT 1.

Here, a case is assumed in which the main current at the IGBT 1 becomes excessively large due to some factor, leading to generation of the overcurrent. As the main current at the IGBT 1 becomes large, the maximum current signal S4 also becomes large. The maximum current signal S4 is compared with the reference voltage REF at the comparison circuit 234. When the size of the maximum current signal S4 exceeds the reference voltage REF, the comparison circuit 234 determines that the overcurrent flows through the IGBT 1 and outputs the protection signal S2 to the driving circuit 211. When receiving the protection signal S2, the driving circuit 211 ignores the driving signal S1 and controls the IGBT 1 so that the IGBT 1 cuts off the main current. As a result, continuous flow of the overcurrent through the IGBT 1 is prevented, and the overcurrent protection function is performed.

Furthermore, the maximum current signal S4 is digitized by the A/D conversion circuit 251 and inputted into the control circuit 253. Similarly to the comparison circuit 234, the control circuit 253 can detect the overcurrent at the IGBT 1 based on a setting value of the reference voltage REF retrieved from the non-volatile memory 254 and the value of the maximum current signal S4. When detecting the overcurrent, the control circuit 253 performs various responsive transactions. Such transactions include generating an alarm notifying the user and the other devices of the overcurrent and stopping the output of the driving signal S1.

In this manner, the overcurrent can be detected by the control circuit 253. In another possible structure, however, overcurrent detection may be left to the determination of the comparison circuit 234. In other words, the control circuit 253 may monitor the determination result by the comparison circuit 234 (for example, the presence or absence of the protection signal S2) to detect the overcurrent and accordingly perform various transactions.

As stated above, the driving device 20 has a function of changing reference levels for overcurrent detection in accordance with the temperature of the IGBT 1. The description of the performance of this function is given in the following. The temperature of the IGBT 1 is measured by the temperature measuring diode 5 and the constant current source 241. Then, the temperature measuring signal S6 that is a voltage signal indicating the temperature of the IGBT 1 is inputted into the A/D conversion circuit 251. The temperature measuring signal S6 is digitized by the A/D conversion circuit 251 and inputted into the control circuit 253.

The control circuit 253 monitors the temperature of the IGBT 1 at predetermined intervals (that is, continuously) based on the digitized temperature measuring signal S6. When there is a change in the temperature of the IGBT 1, the control circuit 253 retrieves the reference voltage REF data corresponding to the changed temperature from the non-volatile memory 254. The D/A conversion circuit 252 converts the data into the reference level control signal S5 that is an analog signal and transmits it to the reference voltage generation circuit 233. The reference voltage generation circuit 233 generates a reference voltage REF of the size in accordance with the reference level control signal S5 (that is, data retrieved by the control circuit 253 from the non-volatile memory 254). In other words, the control circuit 253 functions as a reference level control circuit for adjusting the reference voltage REF that the reference voltage generation circuit 233 produces based on the reference voltage REF data stored in the non-volatile memory 254.

In this manner, the reference voltage REF generated by the reference voltage generation circuit 233 changes in response to the temperature of the IGBT 1. That is, the reference level for overcurrent protection inside the driving device 20 is adjusted in accordance with the temperature of the IGBT 1.

Here, it is assumed that the ratio of the main current to the sense current in the IGBT, that is a diversion ratio (which is obtained by dividing the sense current by the main current), tends to increase with a rise in temperature. That is, when the temperature of the IGBT 1 rises, the sense current flowing through the sense electrode 1a increases and the comparison circuit 234 and the control circuit 253 recognize this as if the main current at the IGBT 1 has increased.

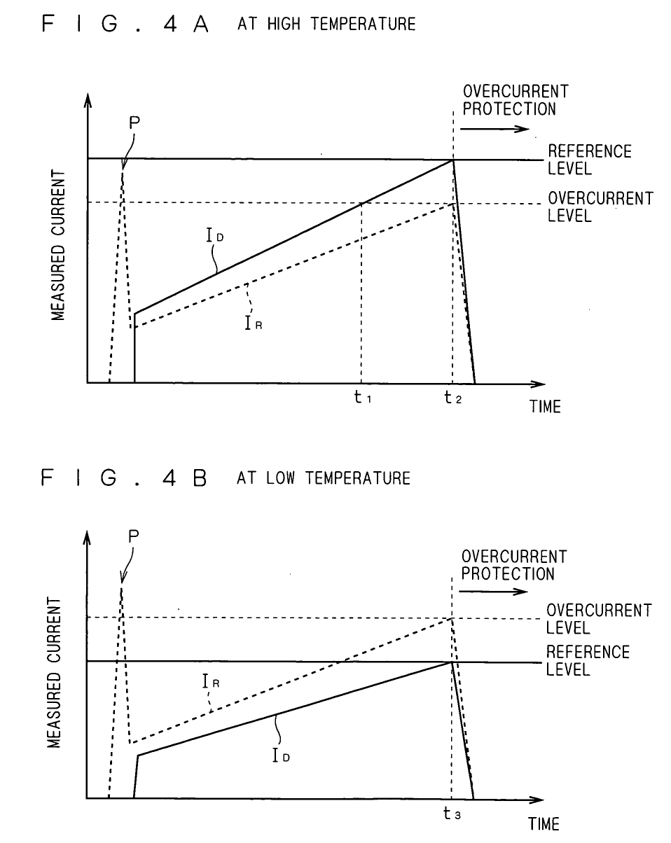

In the present preferred embodiment, the reference voltage generation circuit 233 is controlled to generate a larger reference voltage REF as the temperature of the IGBT 1 rises. In other words, the higher the temperature of the IGBT 1 is, the higher the reference level for overcurrent detection is set. FIG. 4 illustrates changes of reference levels for overcurrent detection in the semiconductor device according to the present preferred embodiment. Both FIGS. 4A and 4B are graphs showing the value of the main current that actually flows through the IGBT 1 (shown by a broken line I_{R}: hereinafter referred to as a “real current I_{R}”) and the maximum value of the main current measured accordingly by the comparison circuit 234 (shown by a solid line I_{D}: hereinafter referred to as a “measured current I_{D}”). Further, a peak in the real current I_{R} indicated as P in the figures represents noise generated when the IGBT 1 is turned on. This peak is removed by the clamping circuit 231 and thus has no influence over the measured current ID measured by the comparison circuit 234.

FIG. 4A shows the real current I_{R} and the measured current I_{D} when the IGBT 1 is at high temperatures. At high temperatures, the measured current I_{D} is measured as having a larger value than the real current I_{R}. That is, the comparison circuit 234 recognizes the main current at the IGBT 1 as larger than it really is. As a result, in the conventional IPM, even though the real current I_{R} does not reach the overcurrent level in reality, the overcurrent protection function is initiated at the time when the measured current I_{D} reaches the overcurrent level (FIG. 4A, timing t₁). Therefore, capacities of the IGBT 1 are not fully utilized.

In the present preferred embodiment, the reference voltage REF outputted from the reference voltage generation circuit 233 becomes large when the IGBT 1 is at high temperatures. Therefore, as shown in FIG. 4A, the reference level at which the comparison circuit 234 detects the overcurrent is set higher than the actual overcurrent level at the IGBT 1. The comparison circuit 234 determines the overcurrent is generated when the measured current I_{D} reaches the reference level. Therefore, the protection circuit portion 23 can initiate the overcurrent protection function at an appropriate timing when the real current I_{R} reaches the real overcurrent level (FIG. 4A, timing t₂).

FIG. 4B shows the real current I_{R} and the measured current I_{D} when the IGBT 1 is at low temperatures. At low temperatures, the measured current I_{D} is measured as having a smaller value than the real current I_{R}. That is, the comparison circuit 234 recognizes the main current at the IGBT 1 as smaller than it really is. As a result, in the conventional IPM, even though the real current I_{R} reaches the overcurrent level in reality, the overcurrent protection function is not initiated unless the measured current I_{D} reaches the overcurrent level, resulting in damage of the IGBT 1 in some cases.

In the present preferred embodiment, the reference voltage REF outputted from the reference voltage generation circuit 233 becomes small when the IGBT 1 is at low temperatures. Therefore, as shown in FIG. 4B, the reference level at which the comparison circuit 234 detects the overcurrent is set lower than the actual overcurrent level at the IGBT 1. The comparison circuit 234 determines the overcurrent is generated when the measured current I_{D} reaches the reference level. Therefore, the protection circuit portion 23 can initiate the overcurrent protection function at an appropriate timing when the real current I_{R} reaches the real overcurrent level (FIG. 4B, timing t₃).

In this manner, according to the present preferred embodiment, the overcurrent detection reference level is appropriately adjusted in accordance with changes of the temperature of the IGBT 1. This allows the protection circuit portion 23 to initiate the overcurrent protection function at an appropriate timing, independent of the changes of the temperature of the IGBT.

Further, unlike above-mentioned Japanese Patent Application Laid-Open No. 2003-009509 where the measured current value is corrected by the correction circuit, the overcurrent detection reference level is changed simply in accordance with the reference voltage REF data stored in the non-volatile memory 254. Therefore, reduction of circuit size can be achieved.

The reference voltage REF data stored in the non-volatile memory 254 can be provided in arbitrary increments of temperature. For example, with the reference voltage REF data that gradually change in small continuous increments (for example, in increments of 1° C.), the overcurrent protection function can be operated with a high accuracy.

<Setting of Overcurrent Detection Reference Level>

As described above, according to the present preferred embodiment, setting values of the reference voltage REF in terms of the temperature of the IGBT 1 are stored in the non-volatile memory 254. Therefore, in case the settings already made for the overcurrent detection reference level are to be changed due to changes of operating conditions of the inverter 10, for example, merely rewriting of the data in the non-volatile memory 254 will suffice. That is, no hardware change is required.

The semiconductor device according to the present preferred embodiment has two types of data setting modes, each employing a different method for changing the reference voltage REF data in the non-volatile memory 254. Description of the two data setting modes is given in the following.

[First Data Setting Mode]

In the first data setting mode, new reference voltage REF data to be stored in the non-volatile memory 254 are inputted from the external device into the control portion 25 of the driving device 20 through the data input/output terminal 26. The control portion 25 has the communication circuit 255 for exchanging data with the external device through the data input/output terminal 26. The data inputted from the data input/output terminal 26 is received by the communication circuit 255, then transmitted to the control circuit 253. The control circuit 253 controls the non-volatile memory 254 to store the reference voltage REF data received from the communication circuit 255. That is, in the first data setting mode, the control circuit 253 functions as a first memory controller. As a result, the reference voltage REF data stored in the non-volatile memory 254 is replaced with the new data inputted from the data input/output terminal 26.

Therefore, in the first data setting mode, the user can rewrite reference voltage REF data previously stored in the non-volatile memory 254 by preparing new reference voltage REF data having the same data structure as shown in FIG. 3 and inputting the new data into the data input/output terminal 26. In this manner, setting of the overcurrent detection reference level can be easily changed.

[Second Data Setting Mode]

In the above first data setting mode, the user needs to prepare new reference voltage REF data having the same data structure as shown in FIG. 3 in advance. For this purpose, separate evaluation or confirmation procedures for determining the overcurrent detection level at each temperature of the IGBT 1 are needed in some cases. If the procedures are executed manually, individual differences or errors in measurement results might occur.

As shown in FIG. 2, the maximum current signal S4 outputted from the maximum value holding circuit 232 of the protection circuit portion 23 and the temperature measuring signal S6 outputted from the temperature measuring portion 24 are digitized by the A/D conversion circuit 251 and then inputted into the control circuit 253.

In the second data setting mode, the control circuit 253 correlates the digitized maximum current signal S4 and the digitized temperature measuring signal S6 to each other in the same structure as shown in FIG. 3. Then the control circuit 253 controls the non-volatile memory 254 to store the data as reference voltage REF data. That is, in the second data setting mode, the control circuit 253 functions as a second memory controller.

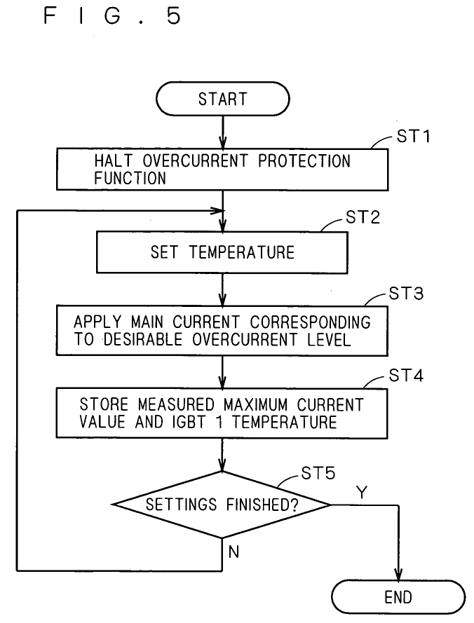

FIG. 5 is a flowchart illustrating the second data setting mode. Prior to the execution of the second data setting mode, the inverter 10 is placed in a constant temperature bath capable of setting the inverter 10 at an arbitrary temperature.

Upon initiating the second data setting mode, the control circuit 253 brings the overcurrent protection function in the protection circuit portion 23 to a halt (step ST 1). This is done, for example, by bringing the operation of the comparison circuit 234 to a halt, or by setting a large reference voltage REF generated by the reference voltage generation circuit 233.

Subsequently, the constant temperature bath sets the inverter 10 at a predetermined temperature (step ST 2), and the main current of the amount corresponding to a desirable overcurrent level is applied to the IGBT 1 (step ST 3). Then the voltage value of the maximum current signal S4 at that moment (corresponding to the maximum value of the measured current value) is related to the temperature of the IGBT 1 obtained from the temperature measuring signal S6. The voltage value with its related temperature is stored in the non-volatile memory 254 as the reference voltage REF data (step S4). Afterwards, aforementioned steps ST 2 through ST 4 are performed repeatedly while gradually changing the temperature of the IGBT 1 for a desired range of temperatures (step S5). As a result, the non-volatile memory 254 is newly provided with a set of overcurrent detection reference level data related to respective temperatures of the IGBT 1.

As described above, in the second data setting mode, by providing the main current corresponding to the overcurrent level with the IGBT 1 while changing the temperature of the IGBT 1, new reference level data is automatically created. Therefore, the user does not have to prepare the reference voltage REF data in advance. Further, even if the procedure is manually executed, there will be no individual differences or errors in measurement results, thereby improving the reliability of the IPM 100 device.

While the invention has been shown and described in detail, the foregoing description is in all aspects illustrative and not restrictive. It is therefore understood that numerous modifications and variations can be devised without departing from the scope of the invention.

1. A semiconductor device for driving a predetermined switching element and having a protection function preventing an overcurrent from flowing through said switching element, said semiconductor device comprising:
a current measuring portion for measuring an amount of current flowing through said switching element;
a protection circuit portion for limiting said current flowing through said switching element when said amount of said current measured by said current measuring portion reaches a predetermined reference level for detecting said overcurrent, thereby protecting said switching element;
a temperature measuring portion for measuring the temperature of said switching element; and
a control portion for adjusting said reference level based on said temperature of said switching element measured by said temperature measuring portion;
wherein said reference level is predetermined in correspondent to said temperature of said switching element on the assumption that said temperature changes, and
said control portion adjusts said reference level in correspondent to said measured temperature.

2. The semiconductor device according to claim 1, wherein
said reference level is set so as to continuously vary in correspondent to a change of said temperature of said switching element, and
said control portion continuously adjust said reference level in correspondent to said temperature measured by said temperature measuring portion.

3. The semiconductor device according to claim 1, said control portion comprising:
a memory for holding data of said reference level related to respective temperatures of said switching element; and
a reference level controller for reading data of said reference level related to said temperature of said switching element measured by said temperature measuring portion from said memory and adjusting said reference level based on said data.

4. The semiconductor device according to claim 3, said control portion further comprising:
a communication unit for communicating data with the outside; and
a first memory controller capable of rewriting said data of said reference level held by said memory controller based on said data received by said communication unit.

5. The semiconductor device according to claim 3, said control portion further comprising a second memory controller for controlling said memory to hold said amount of said current flowing through said switching element measured by said current measuring portion as said data of said reference level, in correspondent to said temperature of said switching element of the time measured by said temperature measuring portion.

6. A data setting method of a reference level for detecting an overcurrent in a semiconductor device for driving a predetermined switching element and having a protection function for preventing said overcurrent from flowing through said switching element,
wherein said semiconductor device comprises:
a current measuring portion for measuring an amount of current flowing through said switching element;
a protection circuit portion for limiting said current flowing through said switching element when said amount of said current measured by said current measuring portion reaches said reference level, thereby protecting said switching element;
a temperature measuring portion for measuring the temperature of said switching element; and
a control portion for adjusting said reference level based on said temperature of said switching element measured by said temperature measuring portion;
wherein said control portion comprises:
a memory for holding data of said reference level related to respective temperatures of said switching element; and
a reference level controller for reading data of said reference level related to said temperature of said switching element measured by said temperature measuring portion from said memory and adjusting said reference level based on said data, and
wherein said data setting method comprises the steps of:
(a) applying a current of a predetermined level to said switching element,
(b) setting said switching element at a predetermined temperature,
(c) measuring the amount of said current flowing through said switching element by said current measuring portion and measuring the temperature of said switching element at the time by said temperature measuring portion, and
(d) controlling said memory to hold said amount of said current and said temperature measured in said step (c) as said data of said reference level by relating each other.
